(19) United States
(12) Patent Application Publication
(10) Pub. No.: US 2025/0048433 A1
(43) Pub. Date: Feb. 6, 2025

(54) MULTIPLE PHYSICAL RANDOM ACCESS CHANNEL TRANSMISSIONS USING FREQUENCY HOPPING

(71) Applicant: QUALCOMM Incorporated, San Diego, CA (US)

(72) Inventors: Hung Dinh LY, San Diego, CA (US); Kexin XIAO, Shanghai (CN); Krishna Kiran MUKKAVILLI, San Diego, CA (US)

(21) Appl. No.: 18/717,606

(22) PCT Filed: Feb. 23, 2022
(86) PCT No.: PCT/CN2022/077447

§ 371 Date: Jun. 7, 2024

(51) Int. Cl. H04W 74/0833

(52) U.S. Cl. CPC H04W 74/0833

(57) ABSTRACT

Various aspects of the present disclosure generally relate to wireless communication. In some aspects, a user equipment (UE) may transmit, to a network entity, multiple physical random access channel (PRACH) transmissions based at least in part on a PRACH slot frequency hopping. The UE may receive, from the network entity, a response based at least in part on the multiple PRACH transmissions associated with the PRACH slot frequency hopping. Numerous other aspects are described.

### FIELD OF THE DISCLOSURE

Aspects of the present disclosure generally relate to wireless communication and to techniques and apparatuses for multiple physical random access channel (PRACH) transmissions using frequency hopping.

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, or the like). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include one or more base stations that support communication for a user equipment (UE) or multiple UEs. A UE may communicate with a base station via downlink communications and uplink communications. “Downlink” (or “DL”) refers to a communication link from the base station to the UE, and “uplink” (or “UL”) refers to a communication link from the UE to the base station.

The above multiple access technologies have been adopted in various telecommunication standards to provide a common protocol that enables different UEs to communicate on a municipal, national, regional, and/or global level. New Radio (NR), which may be referred to as 5G, is a set of enhancements to the LTE mobile standard promulgated by the 3GPP. NR is designed to better support mobile broadband internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink, using CP-OFDM and/or single-carrier frequency division multiplexing (SC-FDM) (also known as discrete Fourier transform spread OFDM (DFT-s-OFDM) on the uplink, as well as supporting beamforming, multiple-input multiple-output (MIMO) antenna technology, and carrier aggregation. As the demand for mobile broadband access continues to increase, further improvements in LTE, NR, and other radio access technologies remain useful.

### SUMMARY

In some implementations, an apparatus for wireless communication at a user equipment (UE) includes a memory and one or more processors, coupled to the memory, configured to: transmit, to a network entity, multiple physical random access channel (PRACH) transmissions based at least in part on a PRACH slot frequency hopping; and receive, from the network entity, a response based at least in part on the multiple PRACH transmissions associated with the PRACH slot frequency hopping.

In some implementations, an apparatus for wireless communication at a network entity includes a memory and one or more processors, coupled to the memory, configured to: receive, from a UE, multiple PRACH transmissions based at least in part on a PRACH slot frequency hopping; and transmit, to the UE, a response based at least in part on the multiple PRACH transmissions associated with the PRACH slot frequency hopping.

In some implementations, a method of wireless communication performed by a UE includes transmitting, to a network entity, multiple PRACH transmissions based at least in part on a PRACH slot frequency hopping; and receiving, from the network entity, a response based at least in part on the multiple PRACH transmissions associated with the PRACH slot frequency hopping.

In some implementations, a method of wireless communication performed by a network entity includes receiving, from a UE, multiple PRACH transmissions based at least in part on a PRACH slot frequency hopping; and transmitting, to the UE, a response based at least in part on the multiple PRACH transmissions associated with the PRACH slot frequency hopping.

In some implementations, a non-transitory computer-readable medium storing a set of instructions for wireless communication includes one or more instructions that, when executed by one or more processors of a UE, cause the UE to: transmit, to a network entity, multiple PRACH transmissions based at least in part on a PRACH slot frequency hopping; and receive, from the network entity, a response based at least in part on the multiple PRACH transmissions associated with the PRACH slot frequency hopping.

In some implementations, a non-transitory computer-readable medium storing a set of instructions for wireless communication includes one or more instructions that, when executed by one or more processors of a network entity, cause the network entity to: receive, from a UE, multiple PRACH transmissions based at least in part on a PRACH slot frequency hopping; and transmit, to the UE, a response based at least in part on the multiple PRACH transmissions associated with the PRACH slot frequency hopping.

In some implementations, an apparatus for wireless communication includes means for transmitting, to a network entity, multiple PRACH transmissions based at least in part on a PRACH slot frequency hopping; and means for receiving, from the network entity, a response based at least in part on the multiple PRACH transmissions associated with the PRACH slot frequency hopping.

In some implementations, an apparatus for wireless communication includes means for receiving, from a UE, multiple PRACH transmissions based at least in part on a PRACH slot frequency hopping; and means for transmitting, to the UE, a response based at least in part on the multiple PRACH transmissions associated with the PRACH slot frequency hopping.

Aspects generally include a method, apparatus, system, computer program product, non-transitory computer-readable medium, user equipment, network entity, base station, wireless communication device, and/or processing system as substantially described herein with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). It is intended that aspects described herein may be practiced in a wide variety of devices, components, systems, distributed arrangements, and/or end-user devices of varying size, shape, and constitution.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with the present disclosure.

FIG. 2 is a diagram illustrating an example of a base station in communication with a user equipment (UE) in a wireless network, in accordance with the present disclosure.

FIG. 3 is a diagram illustrating an example of a disaggregated base station architecture, in accordance with the present disclosure.

FIG. 4 is a diagram illustrating an example of a four-step random access procedure, in accordance with the present disclosure.

FIG. 5 is a diagram illustrating an example of a physical random access channel (PRACH) transmission in a multi-beam system, in accordance with the present disclosure.

FIG. 6 is a diagram illustrating an example of an association pattern for mapping a synchronization signal block (SSB) to random access channel (RACH) occasions, in accordance with the present disclosure.

FIGS. 7-11 are diagrams illustrating examples associated with multiple PRACH transmissions using frequency hopping, in accordance with the present disclosure.

FIGS. 12-13 are diagrams illustrating example processes associated with multiple PRACH transmissions using frequency hopping, in accordance with the present disclosure.

FIGS. 14-15 are diagrams of example apparatuses for wireless communication, in accordance with the present disclosure.

### DETAILED DESCRIPTION

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

While aspects may be described herein using terminology commonly associated with a 5G or New Radio (NR) radio access technology (RAT), aspects of the present disclosure can be applied to other RATs, such as a 3G RAT, a 4G RAT, and/or a RAT subsequent to 5G (e.g., 6G).

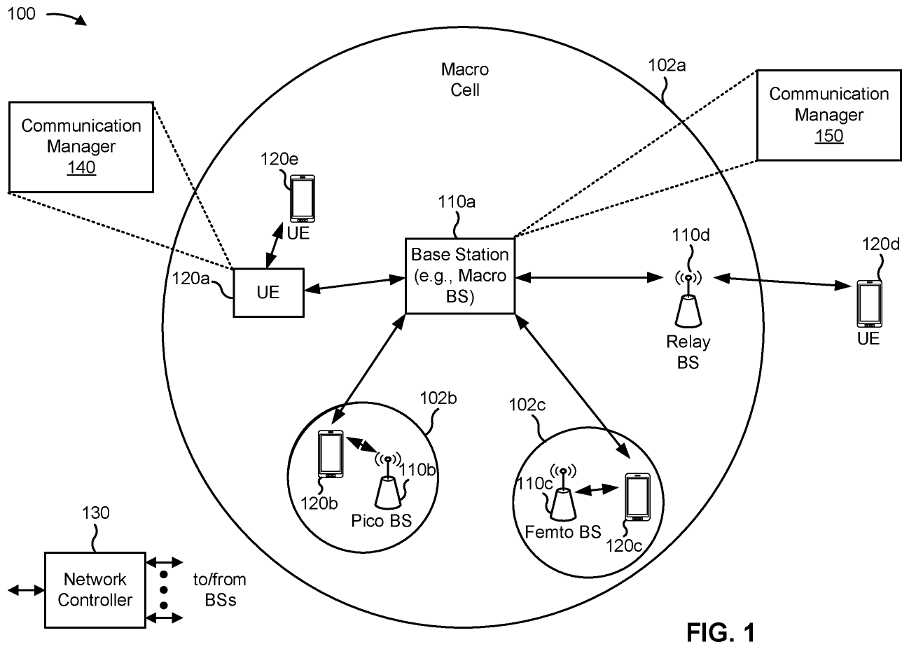

FIG. 1 is a diagram illustrating an example of a wireless network 100, in accordance with the present disclosure. The wireless network 100 may be or may include elements of a 5G (e.g., NR) network and/or a 4G (e.g., Long Term Evolution (LTE)) network, among other examples. The wireless network 100 may include one or more base stations 110 (shown as a BS 110a, a BS 110b, a BS 110c, and a BS 110d), a user equipment (UE) 120 or multiple UEs 120 (shown as a UE 120a, a UE 120b, a UE 120c, a UE 120d, and a UE 120e), and/or other network entities. A base station 110 is an entity that communicates with UEs 120. A base station 110 (sometimes referred to as a BS) may include, for example, an NR base station, an LTE base station, a Node B, an eNB (e.g., in 4G), a gNB (e.g., in 5G), an access point, and/or a transmission reception point (TRP). Each base station 110 may provide communication coverage for a particular geographic area. In the Third Generation Partnership Project (3GPP), the term “cell” can refer to a coverage area of a base station 110 and/or a base station subsystem serving this coverage area, depending on the context in which the term is used.

A base station 110 may provide communication coverage for a macro cell, a pico cell, a femto cell, and/or another type of cell. A macro cell may cover a relatively large geographic area (e.g., several kilometers in radius) and may allow unrestricted access by UEs 120 with service subscriptions. A pico cell may cover a relatively small geographic area and may allow unrestricted access by UEs 120 with service subscription. A femto cell may cover a relatively small geographic area (e.g., a home) and may allow restricted access by UEs 120 having association with the femto cell (e.g., UEs 120 in a closed subscriber group (CSG)). A base station 110 for a macro cell may be referred to as a macro base station. A base station 110 for a pico cell may be referred to as a pico base station. A base station 110 for a femto cell may be referred to as a femto base station or an in-home base station. In the example shown in FIG. 1, the BS 110a may be a macro base station for a macro cell 102a, the BS 110b may be a pico base station for a pico cell 102b, and the BS 110c may be a femto base station for a femto cell 102c. A base station may support one or multiple (e.g., three) cells.

In some aspects, the term “base station” (e.g., the base station 110) or “network entity” may refer to an aggregated base station, a disaggregated base station, an integrated access and backhaul (IAB) node, a relay node, and/or one or more components thereof. For example, in some aspects, “base station” or “network entity” may refer to a central unit (CU), a distributed unit (DU), a radio unit (RU), a Near-Real Time (Near-RT) RAN Intelligent Controller (RIC), or a Non-Real Time (Non-RT) RIC, or a combination thereof. In some aspects, the term “base station” or “network entity” may refer to one device configured to perform one or more functions, such as those described herein in connection with the base station 110. In some aspects, the term “base station” or “network entity” may refer to a plurality of devices configured to perform the one or more functions. For example, in some distributed systems, each of a number of different devices (which may be located in the same geographic location or in different geographic locations) may be configured to perform at least a portion of a function, or to duplicate performance of at least a portion of the function, and the term “base station” or “network entity” may refer to any one or more of those different devices. In some aspects, the term “base station” or “network entity” may refer to one or more virtual base stations and/or one or more virtual base station functions. For example, in some aspects, two or more base station functions may be instantiated on a single device. In some aspects, the term “base station” or “network entity” may refer to one of the base station functions and not another. In this way, a single device may include more than one base station.

In some examples, a cell may not necessarily be stationary, and the geographic area of the cell may move according to the location of a base station 110 that is mobile (e.g., a mobile base station). In some examples, the base stations 110 may be interconnected to one another and/or to one or more other base stations 110 or network nodes (not shown) in the wireless network 100 through various types of backhaul interfaces, such as a direct physical connection or a virtual network, using any suitable transport network.

The wireless network 100 may include one or more relay stations. A relay station is an entity that can receive a transmission of data from an upstream station (e.g., a base station 110 or a UE 120) and send a transmission of the data to a downstream station (e.g., a UE 120 or a base station 110). A relay station may be a UE 120 that can relay transmissions for other UEs 120. In the example shown in FIG. 1, the BS 110d (e.g., a relay base station) may communicate with the BS 110a (e.g., a macro base station) and the UE 120d in order to facilitate communication between the BS 110a and the UE 120d. A base station 110 that relays communications may be referred to as a relay station, a relay base station, a relay, or the like.

The wireless network 100 may be a heterogeneous network that includes base stations 110 of different types, such as macro base stations, pico base stations, femto base stations, relay base stations, or the like. These different types of base stations 110 may have different transmit power levels, different coverage areas, and/or different impacts on interference in the wireless network 100. For example, macro base stations may have a high transmit power level (e.g., 5 to 40 watts) whereas pico base stations, femto base stations, and relay base stations may have lower transmit power levels (e.g., 0.1 to 2 watts).

A network controller 130 may couple to or communicate with a set of base stations 110 and may provide coordination and control for these base stations 110. The network controller 130 may communicate with the base stations 110 via a backhaul communication link. The base stations 110 may communicate with one another directly or indirectly via a wireless or wireline backhaul communication link.

The UEs 120 may be dispersed throughout the wireless network 100, and each UE 120 may be stationary or mobile. A UE 120 may include, for example, an access terminal, a terminal, a mobile station, and/or a subscriber unit. A UE 120 may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (e.g., a smart watch, smart clothing, smart glasses, a smart wristband, smart jewelry (e.g., a smart ring or a smart bracelet)), an entertainment device (e.g., a music device, a video device, and/or a satellite radio), a vehicular component or sensor, a smart meter/sensor, industrial manufacturing equipment, a global positioning system device, and/or any other suitable device that is configured to communicate via a wireless medium.

Some UEs 120 may be considered machine-type communication (MTC) or evolved or enhanced machine-type communication (eMTC) UEs. An MTC UE and/or an eMTC UE may include, for example, a robot, a drone, a remote device, a sensor, a meter, a monitor, and/or a location tag, that may communicate with a base station, another device (e.g., a remote device), or some other entity. Some UEs 120 may be considered Internet-of-Things (IoT) devices, and/or may be implemented as NB-IoT (narrowband IoT) devices. Some UEs 120 may be considered a Customer Premises Equipment. A UE 120 may be included inside a housing that houses components of the UE 120, such as processor components and/or memory components. In some examples, the processor components and the memory components may be coupled together. For example, the processor components (e.g., one or more processors) and the memory components (e.g., a memory) may be operatively coupled, communicatively coupled, electronically coupled, and/or electrically coupled.

In general, any number of wireless networks 100 may be deployed in a given geographic area. Each wireless network 100 may support a particular RAT and may operate on one or more frequencies. A RAT may be referred to as a radio technology, an air interface, or the like. A frequency may be referred to as a carrier, a frequency channel, or the like. Each frequency may support a single RAT in a given geographic area in order to avoid interference between wireless networks of different RATs. In some cases, NR or 5G RAT networks may be deployed.

In some examples, two or more UEs 120 (e.g., shown as UE 120a and UE 120e) may communicate directly using one or more sidelink channels (e.g., without using a base station 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol, a vehicle-to-infrastructure (V2I) protocol, or a vehicle-to-pedestrian (V2P) protocol), and/or a mesh network. In such examples, a UE 120 may perform scheduling operations, resource selection operations, and/or other operations described elsewhere herein as being performed by the base station 110.

Devices of the wireless network 100 may communicate using the electromagnetic spectrum, which may be subdivided by frequency or wavelength into various classes, bands, channels, or the like. For example, devices of the wireless network 100 may communicate using one or more operating bands. In 5G NR, two initial operating bands have been identified as frequency range designations FR1 (410 MHz-7.125 GHz) and FR2 (24.25 GHz-52.6 GHz). It should be understood that although a portion of FR1 is greater than 6 GHZ, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHZ-24.25 GHZ). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHz), FR4 (52.6 GHz-114.25 GHZ), and FR5 (114.25 GHZ-300 GHz). Each of these higher frequency bands falls within the EHF band.

With the above examples in mind, unless specifically stated otherwise, it should be understood that the term “sub-6 GHz” or the like, if used herein, may broadly represent frequencies that may be less than 6 GHZ, may be within FR1, or may include mid-band frequencies. Further, unless specifically stated otherwise, it should be understood that the term “millimeter wave” or the like, if used herein, may broadly represent frequencies that may include mid-band frequencies, may be within FR2, FR4, FR4-a or FR4-1, and/or FR5, or may be within the EHF band. It is contemplated that the frequencies included in these operating bands (e.g., FR1, FR2, FR3, FR4, FR4-a, FR4-1, and/or FR5) may be modified, and techniques described herein are applicable to those modified frequency ranges.

In some aspects, a UE (e.g., UE 120) may include a communication manager 140. As described in more detail elsewhere herein, the communication manager 140 may transmit, to a network entity, multiple physical random access channel (PRACH) transmissions based at least in part on a PRACH slot frequency hopping; and receive, from the network entity, a response based at least in part on the multiple PRACH transmissions associated with the PRACH slot frequency hopping. Additionally, or alternatively, the communication manager 140 may perform one or more other operations described herein.

In some aspects, a network entity (e.g., base station 110) may include a communication manager 150. As described in more detail elsewhere herein, the communication manager 150 may receive, from a UE, multiple PRACH transmissions based at least in part on a PRACH slot frequency hopping; and transmit, to the UE, a response based at least in part on the multiple PRACH transmissions associated with the PRACH slot frequency hopping. Additionally, or alternatively, the communication manager 150 may perform one or more other operations described herein.

As indicated above, FIG. 1 is provided as an example. Other examples may differ from what is described with regard to FIG. 1.

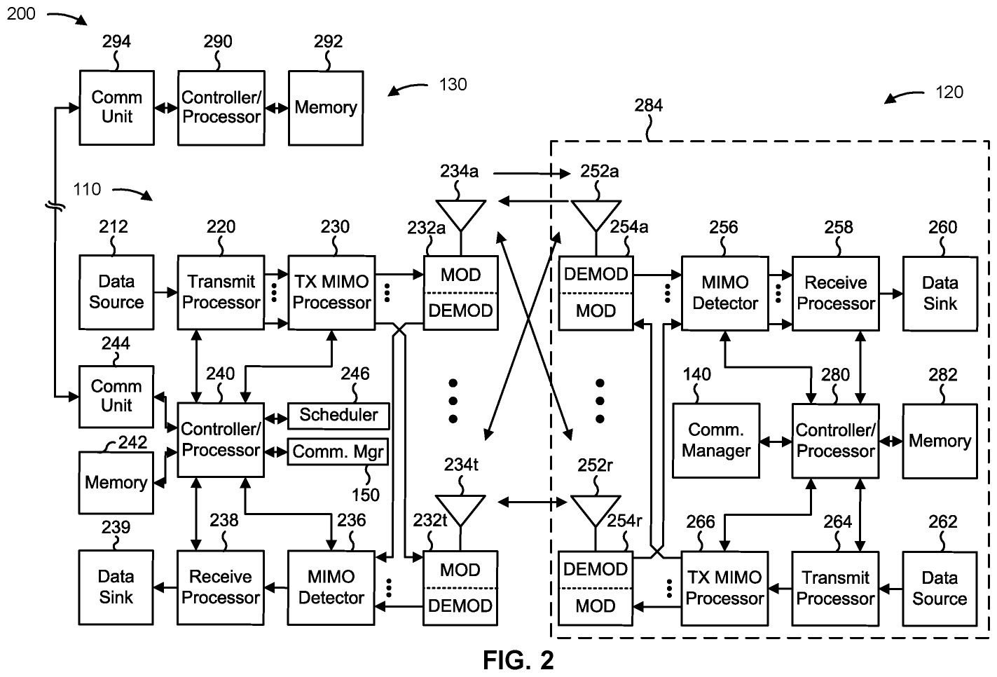

FIG. 2 is a diagram illustrating an example 200 of a base station 110 in communication with a UE 120 in a wireless network 100, in accordance with the present disclosure. The base station 110 may be equipped with a set of antennas 234a through 234t, such as T antennas (T≥1). The UE 120 may be equipped with a set of antennas 252a through 252r, such as R antennas (R≥1).

At the base station 110, a transmit processor 220 may receive data, from a data source 212, intended for the UE 120 (or a set of UEs 120). The transmit processor 220 may select one or more modulation and coding schemes (MCSs) for the UE 120 based at least in part on one or more channel quality indicators (CQIs) received from that UE 120. The base station 110 may process (e.g., encode and modulate) the data for the UE 120 based at least in part on the MCS(s) selected for the UE 120 and may provide data symbols for the UE 120. The transmit processor 220 may process system information (e.g., for semi-static resource partitioning information (SRPI)) and control information (e.g., CQI requests, grants, and/or upper layer signaling) and provide overhead symbols and control symbols. The transmit processor 220 may generate reference symbols for reference signals (e.g., a cell-specific reference signal (CRS) or a demodulation reference signal (DMRS)) and synchronization signals (e.g., a primary synchronization signal (PSS) or a secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide a set of output symbol streams (e.g., T output symbol streams) to a corresponding set of modems 232 (e.g., T modems), shown as modems 232a through 232t. For example, each output symbol stream may be provided to a modulator component (shown as MOD) of a modem 232. Each modem 232 may use a respective modulator component to process a respective output symbol stream (e.g., for OFDM) to obtain an output sample stream. Each modem 232 may further use a respective modulator component to process (e.g., convert to analog, amplify, filter, and/or upconvert) the output sample stream to obtain a downlink signal. The modems 232a through 232t may transmit a set of downlink signals (e.g., T downlink signals) via a corresponding set of antennas 234 (e.g., T antennas), shown as antennas 234a through 234t.

At the UE 120, a set of antennas 252 (shown as antennas 252a through 252r) may receive the downlink signals from the base station 110 and/or other base stations 110 and may provide a set of received signals (e.g., R received signals) to a set of modems 254 (e.g., R modems), shown as modems 254a through 254r. For example, each received signal may be provided to a demodulator component (shown as DEMOD) of a modem 254. Each modem 254 may use a respective demodulator component to condition (e.g., filter, amplify, downconvert, and/or digitize) a received signal to obtain input samples. Each modem 254 may use a demodulator component to further process the input samples (e.g., for OFDM) to obtain received symbols. A MIMO detector 256 may obtain received symbols from the modems 254, may perform MIMO detection on the received symbols if applicable, and may provide detected symbols. A receive processor 258 may process (e.g., demodulate and decode) the detected symbols, may provide decoded data for the UE 120 to a data sink 260, and may provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, and/or a CQI parameter, among other examples. In some examples, one or more components of the UE 120 may be included in a housing 284.

The network controller 130 may include a communication unit 294, a controller/processor 290, and a memory 292. The network controller 130 may include, for example, one or more devices in a core network. The network controller 130 may communicate with the base station 110 via the communication unit 294.

One or more antennas (e.g., antennas 234a through 234t and/or antennas 252a through 252r) may include, or may be included within, one or more antenna panels, one or more antenna groups, one or more sets of antenna elements, and/or one or more antenna arrays, among other examples. An antenna panel, an antenna group, a set of antenna elements, and/or an antenna array may include one or more antenna elements (within a single housing or multiple housings), a set of coplanar antenna elements, a set of non-coplanar antenna elements, and/or one or more antenna elements coupled to one or more transmission and/or reception components, such as one or more components of FIG. 2.

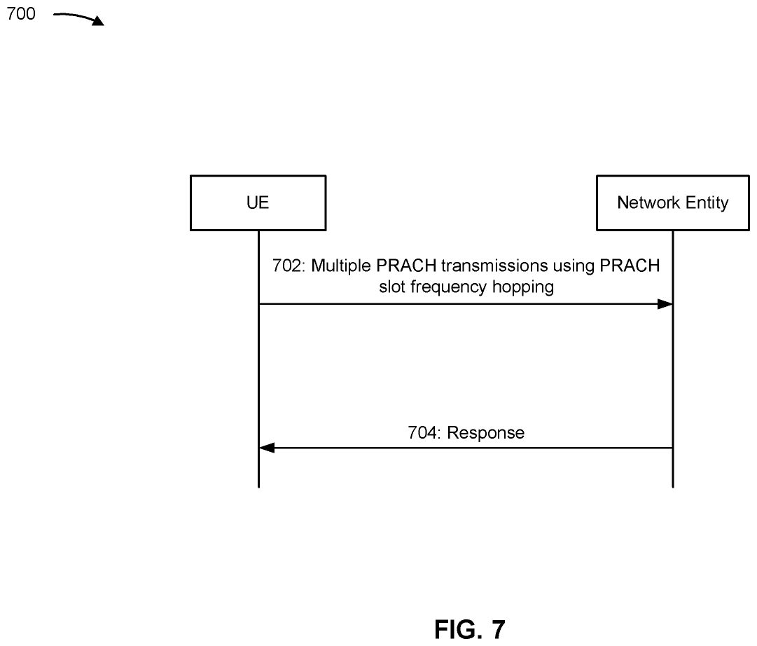

On the uplink, at the UE 120, a transmit processor 264 may receive and process data from a data source 262 and control information (e.g., for reports that include RSRP, RSSI, RSRQ, and/or CQI) from the controller/processor 280. The transmit processor 264 may generate reference symbols for one or more reference signals. The symbols from the transmit processor 264 may be precoded by a TX MIMO processor 266 if applicable, further processed by the modems 254 (e.g., for DFT-s-OFDM or CP-OFDM), and transmitted to the base station 110. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, and/or the TX MIMO processor 266. The transceiver may be used by a processor (e.g., the controller/processor 280) and the memory 282 to perform aspects of any of the methods described herein (e.g., with reference to FIGS. 7-15).

At the base station 110, the uplink signals from UE 120 and/or other UEs may be received by the antennas 234, processed by the modem 232 (e.g., a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The base station 110 may include a communication unit 244 and may communicate with the network controller 130 via the communication unit 244. The base station 110 may include a scheduler 246 to schedule one or more UEs 120 for downlink and/or uplink communications. In some examples, the modem 232 of the base station 110 may include a modulator and a demodulator. In some examples, the base station 110 includes a transceiver. The transceiver may include any combination of the antenna(s) 234, the modem(s) 232, the MIMO detector 236, the receive processor 238, the transmit processor 220, and/or the TX MIMO processor 230. The transceiver may be used by a processor (e.g., the controller/processor 240) and the memory 242 to perform aspects of any of the methods described herein (e.g., with reference to FIGS. 7-15).

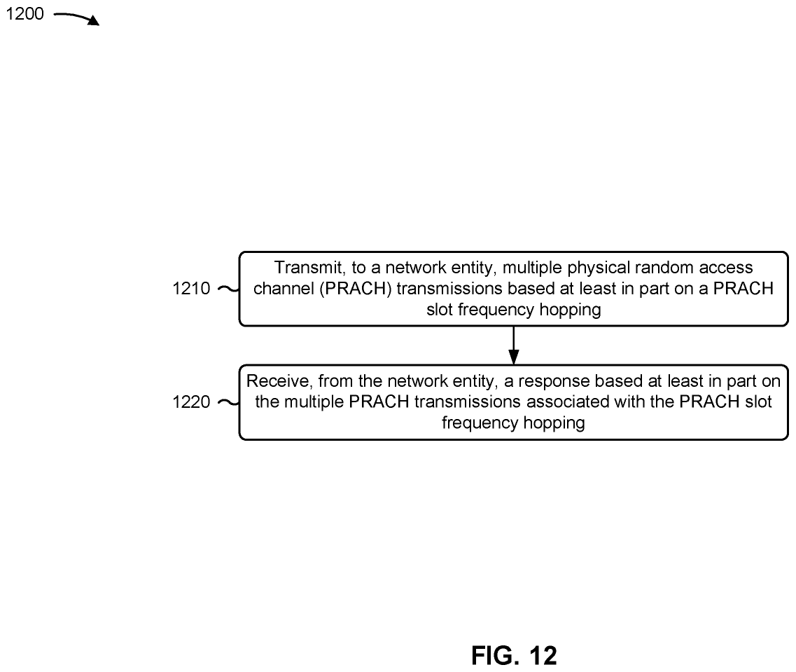

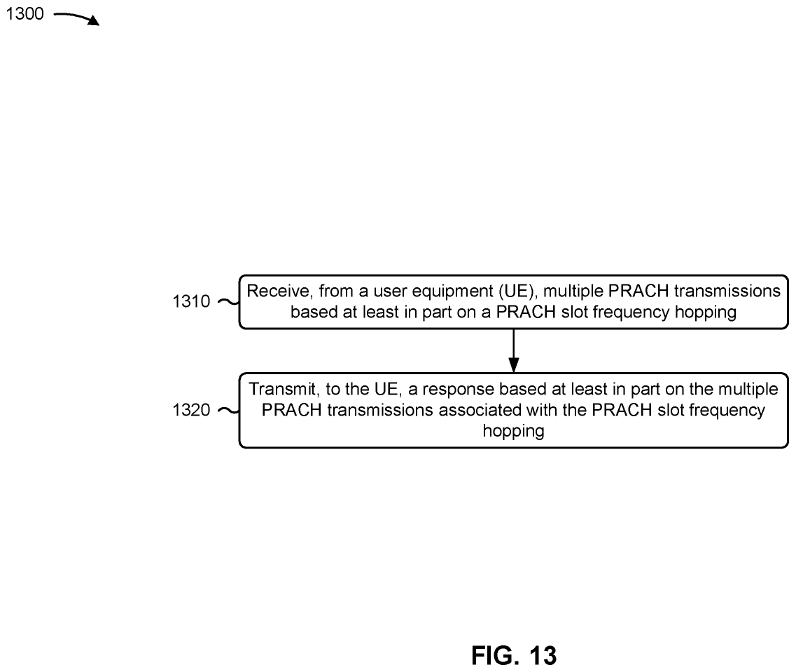

The controller/processor 240 of the base station 110, the controller/processor 280 of the UE 120, and/or any other component(s) of FIG. 2 may perform one or more techniques associated with multiple PRACH transmissions using frequency hopping, as described in more detail elsewhere herein. For example, the controller/processor 240 of the base station 110, the controller/processor 280 of the UE 120, and/or any other component(s) of FIG. 2 may perform or direct operations of, for example, process 1200 of FIG. 12, process 1300 of FIG. 13, and/or other processes as described herein. The memory 242 and the memory 282 may store data and program codes for the base station 110 and the UE 120, respectively. In some examples, the memory 242 and/or the memory 282 may include a non-transitory computer-readable medium storing one or more instructions (e.g., code and/or program code) for wireless communication. For example, the one or more instructions, when executed (e.g., directly, or after compiling, converting, and/or interpreting) by one or more processors of the base station 110 and/or the UE 120, may cause the one or more processors, the UE 120, and/or the base station 110 to perform or direct operations of, for example, process 1200 of FIG. 12, process 1300 of FIG. 13, and/or other processes as described herein. In some examples, executing instructions may include running the instructions, converting the instructions, compiling the instructions, and/or interpreting the instructions, among other examples.

In some aspects, a UE (e.g., UE 120) includes means for transmitting, to a network entity, multiple PRACH transmissions based at least in part on a PRACH slot frequency hopping; and/or means for receiving, from the network entity, a response based at least in part on the multiple PRACH transmissions associated with the PRACH slot frequency hopping. The means for the UE to perform operations described herein may include, for example, one or more of communication manager 140, antenna 252, modem 254, MIMO detector 256, receive processor 258, transmit processor 264, TX MIMO processor 266, controller/processor 280, or memory 282.

In some aspects, a network entity (e.g., base station 110) includes means for receiving, from a UE, multiple PRACH transmissions based at least in part on a PRACH slot frequency hopping; and/or means for transmitting, to the UE, a response based at least in part on the multiple PRACH transmissions associated with the PRACH slot frequency hopping. In some aspects, the means for the network entity to perform operations described herein may include, for example, one or more of communication manager 150, transmit processor 220, TX MIMO processor 230, modem 232, antenna 234, MIMO detector 236, receive processor 238, controller/processor 240, memory 242, or scheduler 246.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

As indicated above, FIG. 2 is provided as an example. Other examples may differ from what is described with regard to FIG. 2.

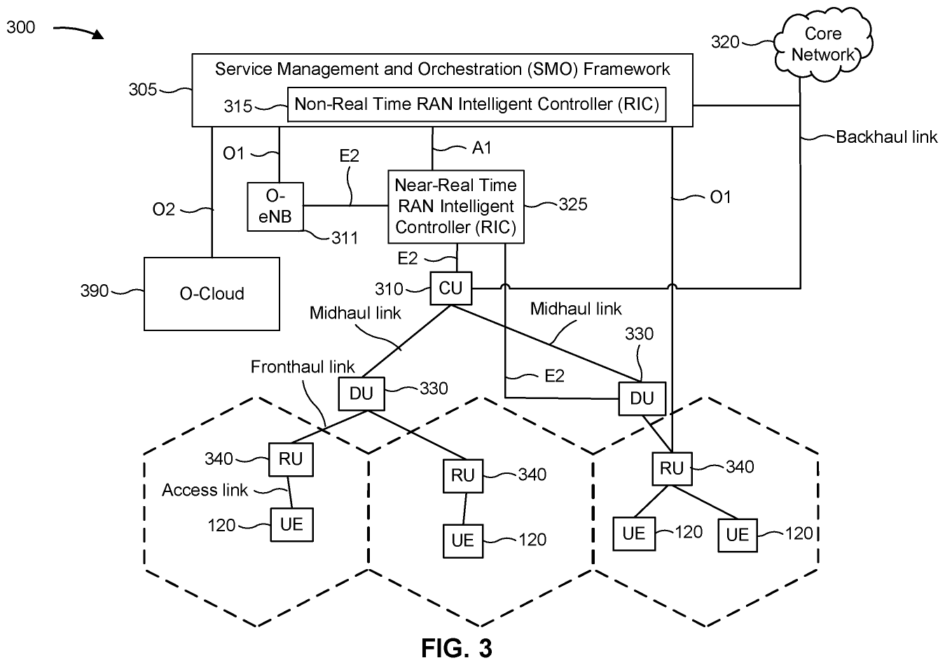

FIG. 3 is a diagram illustrating an example 300 of a disaggregated base station architecture, in accordance with the present disclosure.

Deployment of communication systems, such as 5G NR systems, may be arranged in multiple manners with various components or constituent parts. In a 5G NR system, or network, a network node, a network entity, a mobility element of a network, a RAN node, a core network node, a network element, or a network equipment, such as a base station (BS, e.g., base station 110), or one or more units (or one or more components) performing base station functionality, may be implemented in an aggregated or disaggregated architecture. For example, a BS (such as a Node B (NB), eNB, NR BS, 5G NB, access point (AP), a TRP, a cell, or the like) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more CUs, one or more DUs, or one or more RUs). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU also can be implemented as virtual units, i.e., a virtual centralized unit (VCU), a virtual distributed unit (VDU), or a virtual radio unit (VRU).

Base station-type operation or network design may consider aggregation characteristics of base station functionality. For example, disaggregated base stations may be utilized in an IAB network, an O-RAN (such as the network configuration sponsored by the O-RAN Alliance), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

The disaggregated base station architecture shown in FIG. 3 may include one or more CUs 310 that can communicate directly with a core network 320 via a backhaul link, or indirectly with the core network 320 through one or more disaggregated base station units (such as a Near-Real Time (Near-RT) RAN Intelligent Controller (RIC) 325 via an E2 link, or a Non-Real Time (Non-RT) RIC 315 associated with a Service Management and Orchestration (SMO) Framework 305, or both). A CU 310 may communicate with one or more DUs 330 via respective midhaul links, such as an F1 interface. The DUs 330 may communicate with one or more RUs 340 via respective fronthaul links. The RUs 340 may communicate with respective UEs 120 via one or more radio frequency (RF) access links. In some implementations, the UE 120 may be simultaneously served by multiple RUs 340.

Each of the units (e.g., the CUS 310, the DUs 330, the RUs 340), as well as the Near-RT RICs 325, the Non-RT RICs 315, and the SMO Framework 305, may include one or more interfaces or be coupled to one or more interfaces configured to receive or transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or transmit signals over a wired transmission medium to one or more of the other units. Additionally, the units can include a wireless interface, which may include a receiver, a transmitter or transceiver (such as an RF transceiver), configured to receive or transmit signals, or both, over a wireless transmission medium to one or more of the other units.

In some aspects, the CU 310 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 310. The CU 310 may be configured to handle user plane functionality (e.g., Central Unit-User Plane (CU-UP)), control plane functionality (e.g., Central Unit-Control Plane (CU-CP)), or a combination thereof. In some implementations, the CU 310 can be logically split into one or more CU-UP units and one or more CU-CP units. The CU-UP unit can communicate bidirectionally with the CU-CP unit via an interface, such as the E1 interface when implemented in an O-RAN configuration. The CU 310 can be implemented to communicate with the DU 330, as necessary, for network control and signaling.

The DU 330 may correspond to a logical unit that includes one or more base station functions to control the operation of one or more RUs 340. In some aspects, the DU 330 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3rd Generation Partnership Project (3GPP). In some aspects, the DU 330 may further host one or more low-PHY layers. Each layer (or module) can be implemented with an interface configured to communicate signals with other layers (and modules) hosted by the DU 330, or with the control functions hosted by the CU 310.

Lower-layer functionality can be implemented by one or more RUs 340. In some deployments, an RU 340, controlled by a DU 330, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 340 can be implemented to handle over the air (OTA) communication with one or more UEs 120. In some implementations, real-time and non-real-time aspects of control and user plane communication with the RU(s) 340 can be controlled by the corresponding DU 330. In some scenarios, this configuration can enable the DU(s) 330 and the CU 310 to be implemented in a cloud-based RAN architecture, such as a vRAN architecture.

The SMO Framework 305 may be configured to support RAN deployment and provisioning of non-virtualized and virtualized network elements. For non-virtualized network elements, the SMO Framework 305 may be configured to support the deployment of dedicated physical resources for RAN coverage requirements which may be managed via an operations and maintenance interface (such as an O1 interface). For virtualized network elements, the SMO Framework 305 may be configured to interact with a cloud computing platform (such as an open cloud (O-Cloud) 390) to perform network element life cycle management (such as to instantiate virtualized network elements) via a cloud computing platform interface (such as an O2 interface). Such virtualized network elements can include, but are not limited to, CUs 310, DUs 330, RUs 340 and Near-RT RICs 325. In some implementations, the SMO Framework 305 can communicate with a hardware aspect of a 4G RAN, such as an open eNB (O-eNB) 311, via an O1 interface. Additionally, in some implementations, the SMO Framework 305 can communicate directly with one or more RUs 340 via an O1 interface. The SMO Framework 305 also may include a Non-RT RIC 315 configured to support functionality of the SMO Framework 305.

The Non-RT RIC 315 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 325.

The Non-RT RIC 315 may be coupled to or communicate with (such as via an AI interface) the Near-RT RIC 325. The Near-RT RIC 325 may be configured to include a logical function that enables near-real-time control and optimization of RAN elements and resources via data collection and actions over an interface (such as via an E2 interface) connecting one or more CUs 310, one or more DUs 330, or both, as well as an O-eNB, with the Near-RT RIC 325.

In some implementations, to generate AI/ML models to be deployed in the Near-RT RIC 325, the Non-RT RIC 315 may receive parameters or external enrichment information from external servers. Such information may be utilized by the Near-RT RIC 325 and may be received at the SMO Framework 305 or the Non-RT RIC 315 from non-network data sources or from network functions. In some examples, the Non-RT RIC 315 or the Near-RT RIC 325 may be configured to tune RAN behavior or performance. For example, the Non-RT RIC 315 may monitor long-term trends and patterns for performance and employ AI/ML models to perform corrective actions through the SMO Framework 305 (such as reconfiguration via 01) or via creation of RAN management policies (such as A1 policies).

As indicated above, FIG. 3 is provided as an example. Other examples may differ from what is described with regard to FIG. 3.

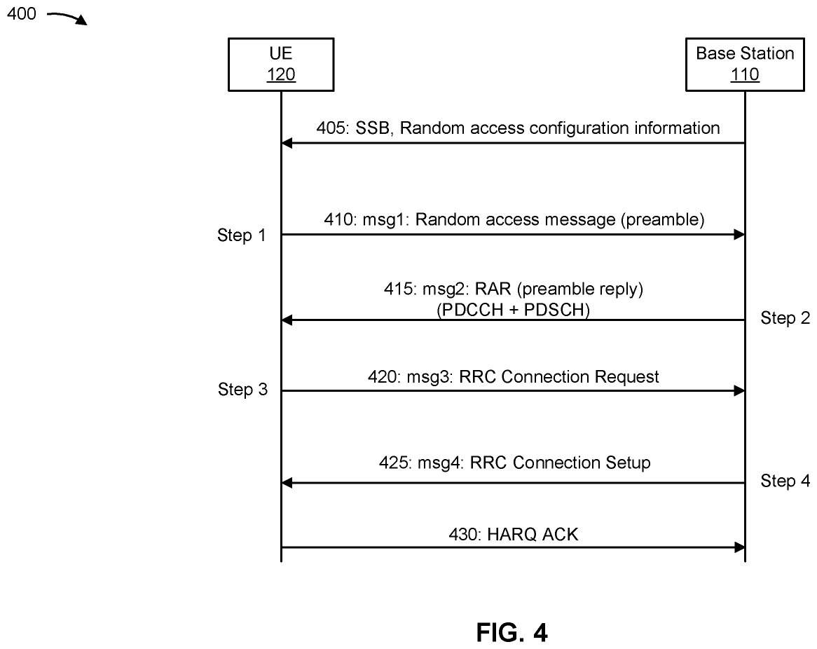

FIG. 4 is a diagram illustrating an example 400 of a four-step random access procedure, in accordance with the present disclosure. As shown in FIG. 4, a base station 110 and a UE 120 may communicate with one another to perform the four-step random access procedure.

As shown by reference number 405, the base station 110 may transmit, and the UE 120 may receive, one or more synchronization signal blocks (SSBs) and random access configuration information. In some aspects, the random access configuration information may be transmitted in and/or indicated by system information (e.g., in one or more system information blocks (SIBs)) and/or an SSB, such as for contention-based random access. Additionally, or alternatively, the random access configuration information may be transmitted in an RRC message and/or a physical downlink control channel (PDCCH) order message that triggers a random access channel (RACH) procedure, such as for contention-free random access. The random access configuration information may include one or more parameters to be used in the random access procedure, such as one or more parameters for transmitting a random access message (RAM) and/or one or more parameters for receiving a random access response (RAR).

As shown by reference number 410, the UE 120 may transmit a RAM, which may include a preamble (sometimes referred to as a random access preamble, a PRACH preamble, or a RAM preamble). The message that includes the preamble may be referred to as a message 1, msg1, MSG1, a first message, or an initial message in a four-step random access procedure. The random access message may include a random access preamble identifier.

As shown by reference number 415, the base station 110 may transmit an RAR as a reply to the preamble. The message that includes the RAR may be referred to as message 2, msg2, MSG2, or a second message in a four-step random access procedure. In some aspects, the RAR may indicate the detected random access preamble identifier (e.g., received from the UE 120 in msg1). Additionally, or alternatively, the RAR may indicate a resource allocation to be used by the UE 120 to transmit message 3 (msg3).

In some aspects, as part of the second step of the four-step random access procedure, the base station 110 may transmit a PDCCH communication for the RAR. The PDCCH communication may schedule a physical downlink shared channel (PDSCH) communication that includes the RAR. For example, the PDCCH communication may indicate a resource allocation for the PDSCH communication. Also as part of the second step of the four-step random access procedure, the base station 110 may transmit the PDSCH communication for the RAR, as scheduled by the PDCCH communication. The RAR may be included in a media access control (MAC) protocol data unit (PDU) of the PDSCH communication.

As shown by reference number 420, the UE 120 may transmit an RRC connection request message. The RRC connection request message may be referred to as message 3, msg3, MSG3, or a third message of a four-step random access procedure. In some aspects, the RRC connection request may include a UE identifier, uplink control information (UCI), and/or a physical uplink shared channel (PUSCH) communication (e.g., an RRC connection request).

As shown by reference number 425, the base station 110 may transmit an RRC connection setup message. The RRC connection setup message may be referred to as message 4, msg4, MSG4, or a fourth message of a four-step random access procedure. In some aspects, the RRC connection setup message may include the detected UE identifier, a timing advance value, and/or contention resolution information. As shown by reference number 430, if the UE 120 successfully receives the RRC connection setup message, the UE 120 may transmit a hybrid automatic repeat request (HARQ) acknowledgement (ACK).

In some aspects, the UE may transmit multiple PRACH transmissions based at least in part on a PRACH slot frequency hopping. The PRACH slot frequency hopping may be an intra-PRACH slot frequency hopping or an inter-PRACH slot frequency hopping. The UE may transmit the multiple PRACH transmissions based at least in part on capability signaling associated with a UE capability.

As indicated above, FIG. 4 is provided as an example. Other examples may differ from what is described with regard to FIG. 4.

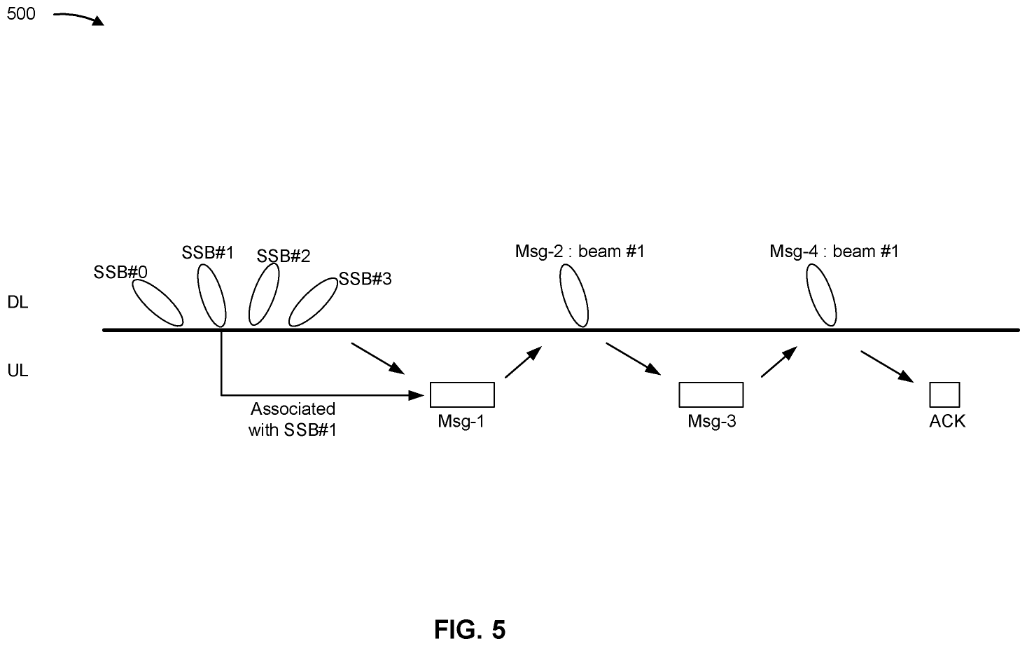

FIG. 5 is a diagram illustrating an example 500 of a PRACH transmission in a multi-beam system, in accordance with the present disclosure.

As shown in FIG. 5, a UE may perform a PRACH transmission (Msg1) in a multi-beam system. A network entity may transmit a system information block (SIB) to the UE in a downlink. The SIB may configure a synchronization signal block (SSB) random access channel (RACH) occasion (RO) mapping. The SSB-RO mapping may be associated with a plurality of SSBs with associated beams, such as SSB #0 and beam #0, SSB #1 and beam #1, SSB #2 and beam #2, and SSB #3 and beam #3. The UE may determine an RSRP associated with each of the plurality of SSBs. The UE may select an SSB (e.g., SSB #1 associated with beam #1) from the plurality of SSBs based at least in part on an RSRP value associated with the SSB, in relation to RSRP values associated with other SSBs of the plurality of SSBs. The UE may select a PRACH resource associated with the selected SSB. The UE may transmit, to the network entity, the PRACH transmission using a spatial filter associated with the selected SSB. The network entity may receive the PRACH transmission from the UE. The network may use a same beam (e.g., beam #1 associated with SSB #1) to transmit, to the UE in a downlink, a PDCCH/PDSCH transmission (Msg2) and a PDCCH/PDSCH transmission (Msg4). The UE may transmit, to the network entity, a PUSCH transmission (Msg3) in an uplink using the spatial filter associated with the selected SSB (e.g., the same spatial filter used to transmit the PRACH transmission).

During a RACH procedure (e.g., a four-step RACH procedure), the UE may perform multiple PRACH transmissions. The UE may perform the multiple PRACH transmissions using a same beam or different beams. The UE may perform the multiple PRACH transmissions in FR2 and/or FR1. The UE may perform the multiple PRACH transmissions using short PRACH formats or other applicable formats.

As indicated above, FIG. 5 is provided as an example. Other examples may differ from what is described with regard to FIG. 5.

For a Type-1 random access procedure, a UE may be provided a number N of synchronization signal (SS)/physical broadcast channel (PBCH) block indexes associated with one PRACH occasion and a number R of contention-based preambles per SS/PBCH block index per valid PRACH occasion by a ssb-perRACH-Occasion AndCB-PreamblesPerSSB parameter.

“PRACH occasion” and “RO” may be used interchangeably herein. “SS/PBCH block” and “SSB” may be used interchangeably herein.

For the Type-1 random access procedure, or for a Type-2 random access procedure with a separate configuration of PRACH occasions from the Type 1 random access procedure, when N<1, one SS/PBCH block index may be mapped to 1/N consecutive valid PRACH occasions and R contention-based preambles with consecutive indexes associated with the SS/PBCH block index per valid PRACH occasion may start from preamble index 0. When N≥1, R contention-based preambles with consecutive indexes associated with SS/PBCH block index n, 0≤n≤N−1, per valid PRACH occasion may start from preamble index n·N_{preamble}^{total}/N where N_{preamble}^{total} is provided by a totalNumberOfRA-Preambles parameter for the Type-1 random access procedure.

SS/PBCH block indexes provided by a ssb-PositionsInBurst parameter in a system information block type 1 (SIB1) or in a Serving CellConfigCommon parameter may be mapped to valid PRACH occasions in accordance with the following order: first, in increasing order of preamble indexes within a single PRACH occasion; second, in increasing order of frequency resource indexes for frequency multiplexed PRACH occasions; third, in increasing order of time resource indexes for time multiplexed PRACH occasions within a PRACH slot; and fourth, in increasing order of indexes for PRACH slots.

An association period, starting from frame 0, for mapping SS/PBCH block indexes to PRACH occasions may be a smallest value in a set determined by a PRACH configuration period, such that N_{Tx}^{SSB} SS/PBCH block indexes may be mapped at least once to the PRACH occasions within the association period, where a UE may obtain N_{Tx}^{SSB} from a value of the ssb-PositionsInBurst parameter in the SIB1 or from a value of the ServingCellConfigCommon parameter. After an integer number of SS/PBCH block indexes to PRACH occasions mapping cycles within the association period, when a set of PRACH occasions or PRACH preambles are not mapped to N_{Tx}^{SSB} SS/PBCH block indexes, no SS/PBCH block indexes may be mapped to the set of PRACH occasions or PRACH preambles. An association pattern period may include one or more association periods and may be determined so that a pattern between PRACH occasions and SS/PBCH block indexes repeats at most every 160 milliseconds. PRACH occasions not associated with SS/PBCH block indexes after an integer number of association periods, if any, may not be used for PRACH transmissions.

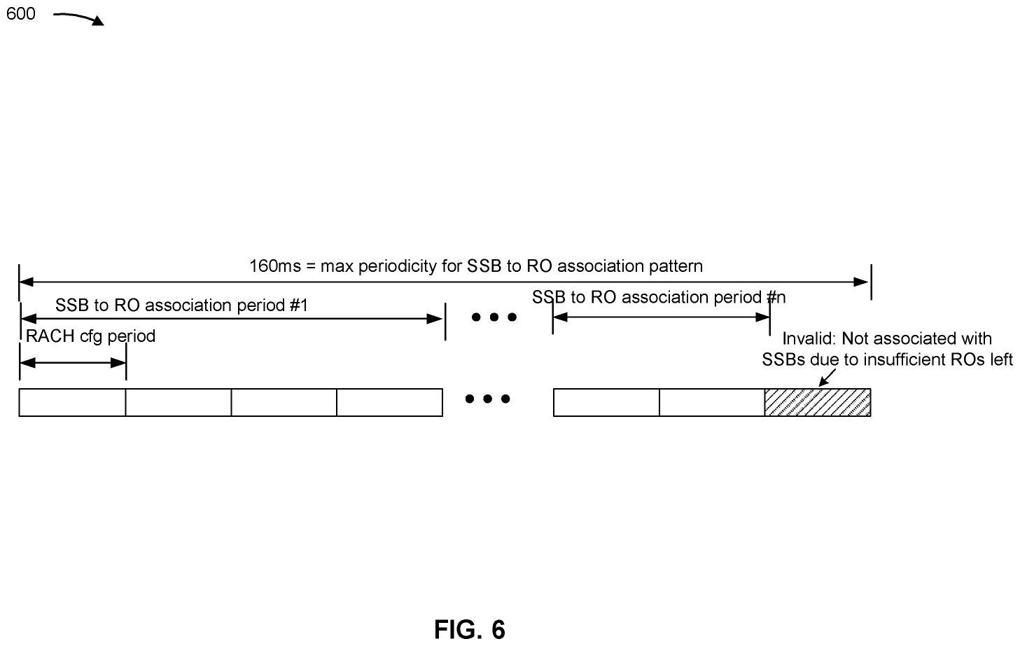

FIG. 6 is a diagram illustrating an example 600 of an association pattern for mapping an SSB to ROs, in accordance with the present disclosure.

As shown in FIG. 6, an SSB-to-RO association pattern may be defined with a maximum periodicity (e.g., 160 msec). The SSB-to-RO association pattern may include a plurality of SSB-to-RO association periods. An SSB-to-RO association period may include a plurality of RACH configuration periods. A RACH configuration period that is outside of an SSB-to-RO association period but within the SSB-to-RO association pattern may be invalid, and may not be associated with SSBs due to insufficient ROs remaining in the SSB-to-RO association period.

As indicated above, FIG. 6 is provided as an example. Other examples may differ from what is described with regard to FIG. 6.

Multiple PRACH transmissions (e.g., repeated PRACH transmissions) may be transmitted with a same spatial domain filter, which may be associated with a suitable SSB (e.g., a strongest SSB) or channel state information reference signal (CSI-RS). Alternatively, the multiple PRACH transmissions may be transmitted with different spatial domain filters, which may be associated with different SSBs or different CSI-RSs. However, the multiple PRACH transmissions may suffer from poor frequency diversity and/or an increased likelihood of collisions from multiple UEs.

In various aspects of techniques and apparatuses described herein, a UE may transmit, to a network entity, multiple PRACH transmissions based at least in part on a PRACH slot frequency hopping. The PRACH slot frequency hopping may be an intra-PRACH slot frequency hopping or an inter-PRACH slot frequency hopping. The UE may transmit the multiple PRACH transmissions based at least in part on capability signaling and/or a PRACH slot frequency hopping configuration received from the network entity.

In some aspects, a PRACH performance for multiple PRACH transmissions may be improved using frequency hopping, which may enhance the frequency diversity and mitigate PRACH collisions from multiple UEs. For example, different UEs may be configured with different PRACH occasion offsets for the same beam at the same time. The frequency hopping for the multiple PRACH transmissions may be intra-PRACH slot frequency hopping or inter-PRACH slot frequency hopping. The PRACH transmissions may occur during a four-step RACH procedure or during a two-step RACH procedure.

FIG. 7 is a diagram illustrating an example 700 associated with multiple PRACH transmissions using frequency hopping, in accordance with the present disclosure. As shown in FIG. 7, example 700 includes communication between a UE (e.g., UE 120) and a network entity (e.g., base station 110). In some aspects, the UE and the network entity may be included in a wireless network, such as wireless network 100.

As shown by reference number 702, the UE may transmit, to the network entity, multiple PRACH transmissions based at least in part on a PRACH slot frequency hopping. The multiple PRACH transmissions may be repeated PRACH transmissions. The PRACH slot frequency hopping may be an intra-PRACH slot frequency hopping (e.g., frequency hopping within a PRACH slot) or an inter-PRACH slot frequency hopping (e.g., frequency hopping between PRACH slots). With frequency hopping, the UE may perform the multiple PRACH transmissions at different frequencies within the PRACH slot (intra frequency hopping) or between the PRACH slots (inter frequency hopping), which may increase frequency diversity and decrease a likelihood of collisions between multiple UEs. A PRACH slot may include a plurality of PRACH occasions in a frequency domain and/or a time domain. The UE may transmit the multiple PRACH transmissions using the same spatial domain filters or the same transmit beams. Alternatively, the UE may transmit the multiple PRACH transmissions using different spatial domain filters or different transmit beams.

In some aspects, the UE may transmit, to the network entity, capability signaling that includes a PRACH slot frequency hopping indication, which may indicate that the UE is capable of performing multiple PRACH transmissions with PRACH slot frequency hopping. The UE may transmit the multiple PRACH transmissions based at least in part on the capability signaling. The capability signaling may indicate whether the UE is capable of performing multiple PRACH transmissions using intra-PRACH slot frequency hopping or inter-PRACH slot frequency hopping. The capability signaling may indicate whether the UE is capable of performing multiple PRACH transmissions using the same spatial domain filters (e.g., the same transmit beams) or different spatial domain filters (e.g., different transmit beams).

In some aspects, when the UE performs the multiple PRACH transmissions, the UE may be configured with intra-PRACH slot frequency hopping. The UE may perform intra-PRACH slot frequency hopping based at least in part on the PRACH slot frequency hopping indication, which may indicate that the UE is capable of performing multiple PRACH transmissions using intra-PRACH slot frequency hopping. The UE may perform multiple PRACH transmissions using the same or different spatial domain filters (e.g., the same or different transmit beams).

In some aspects, the multiple PRACH transmissions may be associated with a common PRACH slot frequency hopping flag indicating that PRACH slot frequency hopping is enabled. In some aspects, the multiple PRACH transmissions may each be associated with a separate PRACH slot frequency hopping flag that indicates whether PRACH slot frequency hopping is enabled.

In some aspects, an intra-PRACH slot frequency hopping flag may be common for multiple PRACH transmissions using the same spatial domain filters and multiple PRACH transmissions using different spatial domain filters. An intra-PRACH slot frequency hopping flag may be separate for multiple PRACH transmissions using the same spatial domain filters and multiple PRACH transmissions using different spatial domain filters. Alternatively, the UE may perform intra-PRACH slot frequency hopping based at least in part on UE capability signaling that indicates the UE is capable of multiple PRACH transmissions with the same spatial domain filter. However, an intra-PRACH slot frequency hopping flag may be configured to indicate intra-PRACH slot frequency hopping for multiple PRACH transmissions with different spatial domain filters.

In some aspects, the UE may receive, from the network entity, a PRACH slot frequency hopping configuration. In other words, the PRACH slot frequency hopping configuration may be configured to the UE. The PRACH slot frequency hopping configuration may indicate a frequency hop offset in terms of a quantity of resource blocks in a PRACH occasion or a quantity of PRACH occasions in a PRACH slot. The PRACH slot frequency hopping configuration may indicate a quantity of hops, where the quantity of hops may be based at least in part on a quantity of SSBs associated with the PRACH occasion (N) and a quantity of frequency division multiplexed PRACH occasions. In other words, the PRACH slot frequency hopping configuration may depend on the quantity of SSBs associated with the PRACH occasion and the quantity of frequency division multiplexed PRACH occasions. The PRACH slot frequency hopping configuration may be common for multiple PRACH transmissions using the same spatial domain filters, separate for multiple PRACH transmissions using the same spatial domain filters, common for multiple PRACH transmissions using different spatial domain filters, or separate for multiple PRACH transmissions using different spatial domain filters. The UE may transmit the multiple PRACH transmissions based at least in part on the PRACH slot frequency hopping configuration.

In some aspects, the PRACH slot frequency hopping may be based at least in part on a system frame number (SFN), a slot number, and/or an association period associated with multiple PRACH transmissions. For example, the frequency hop offset (or a hop index) may depend on the SFN, the slot number, and/or the association period.

In some aspects, intra-PRACH slot frequency hopping in multiple PRACH transmissions may be based at least in part on an intra-PRACH slot frequency hopping configuration. The frequency hop offset may be in terms of the quantity of resource blocks in a PRACH occasion or a quantity of PRACH occasions in a PRACH slot. The frequency hop offset may be fixed or configured to the UE via the network entity. In the intra-PRACH slot frequency hopping, a first hop may be at a first valid PRACH occasion, or at a valid PRACH occasion configured to the UE in the PRACH slot. A quantity of hops (e.g., two hops) may be fixed or configured to the UE via the network entity. The quantity of hops may depend on the quantity of SSBs associated with the PRACH occasion (N) and the number of frequency division multiplexed PRACH occasions (e.g., msg1-FDM). For example, for msg1-FDM=8, if N is greater than 1/4, the quantity of hops is one. Otherwise, the quantity of hops may be two. Further, frequency hopping patterns in PRACH slots may be identical for PRACH transmissions with the same spatial filter. In some aspects, the intra-PRACH slot frequency hopping configuration may be common or separate for multiple PRACH transmissions using the same spatial domain filters and for multiple PRACH transmissions using different spatial domain filters.

In some aspects, intra-PRACH slot frequency hopping and inter-PRACH slot frequency hopping may not be configured at the same time. For example, the UE may only perform one frequency hopping type (e.g., intra-PRACH slot frequency hopping or inter-PRACH slot frequency hopping) for multiple PRACH transmissions. Inter-PRACH slot frequency hopping may be applicable to multiple PRACH transmissions with the same spatial domain filters and/or multiple PRACH transmissions with different spatial domain filters.

As shown by reference number 704, the UE may receive, from the network entity, a response (e.g., a RAR or Msg2) based at least in part on the multiple PRACH transmissions associated with the PRACH slot frequency hopping. The network entity may transmit the response after receiving the multiple PRACH transmissions associated with the PRACH slot frequency hopping from the UE.

As indicated above, FIG. 7 is provided as an example. Other examples may differ from what is described with regard to FIG. 7.

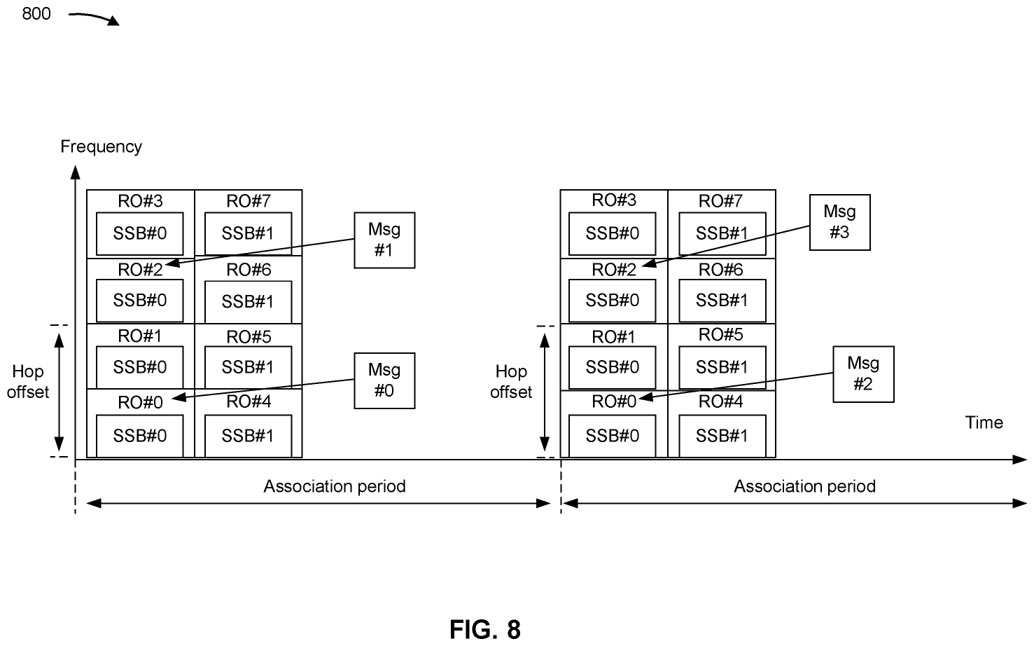

FIG. 8 is a diagram illustrating an example 800 associated with multiple PRACH transmissions using frequency hopping, in accordance with the present disclosure.

In some aspects, a UE may transmit multiple PRACH (Msg1) transmissions to a network entity using intra-PRACH slot frequency hopping. A first association period may include a first PRACH slot, and a second association period may include a second PRACH slot. Each PRACH slot may be associated with 8 PRACH occasions in a frequency domain and in a time domain (e.g., RO #0 to RO #7).

As shown in FIG. 8, in the first PRACH slot, a first PRACH transmission (Msg1 #0) may be transmitted in a first PRACH occasion (RO #0) using a first SSB (SSB #0), and a second PRACH transmission (Msg1 #1) may be transmitted in a third PRACH occasion (RO #2) using the first SSB. In the second PRACH slot, a third PRACH transmission (Msg1 #2) may be transmitted in a first PRACH occasion using the first SSB, and a fourth PRACH transmission (Msg1 #3) may be transmitted in a third PRACH occasion using the first SSB. In this example, a frequency hop offset is two PRACH occasions, N is 1/4 (e.g., one SSB associated with four PRACH occasions), the number of frequency division multiplexed PRACH occasions is four, the number of SSBs (NESB) is two, and a quantity of repetitions is four. Further, in this example, the UE may transmit the multiple PRACH transmissions using two hops and same spatial domain filters. The UE may transmit the multiple PRACH transmissions using a hopping configuration for the second PRACH slot that is the same as a hopping configuration for the first PRACH slot.

As indicated above, FIG. 8 is provided as an example. Other examples may differ from what is described with regard to FIG. 8.

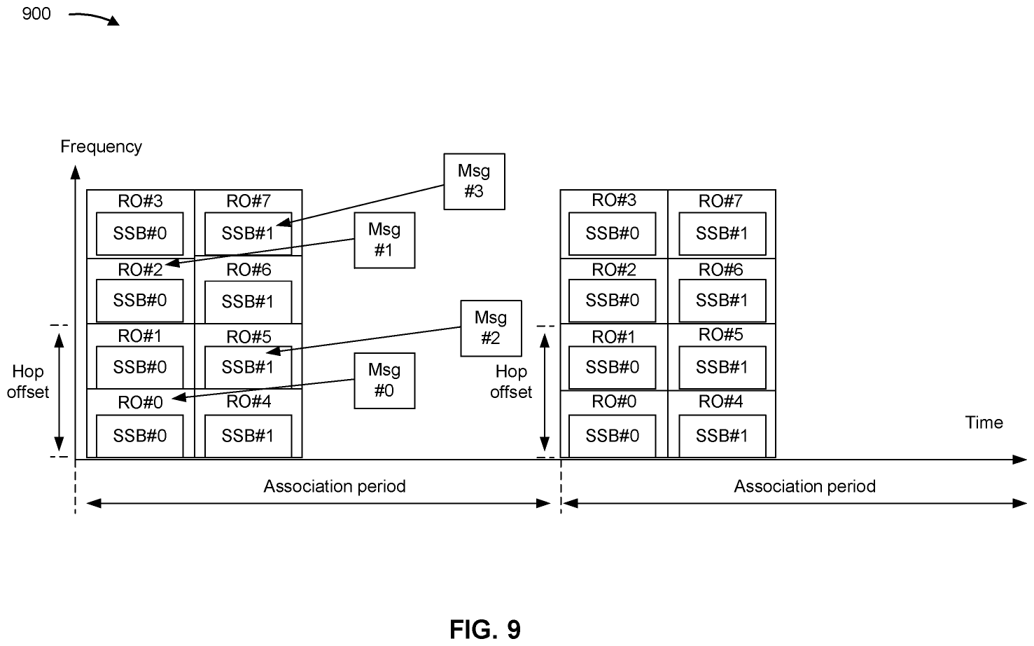

FIG. 9 is a diagram illustrating an example 900 associated with multiple PRACH transmissions using frequency hopping, in accordance with the present disclosure.

In some aspects, a UE may transmit multiple PRACH (Msg1) transmissions to a network entity using intra-PRACH slot frequency hopping. A first association period may include a first PRACH slot, and a second association period may include a second PRACH slot. Each PRACH slot may be associated with 8 PRACH occasions in a frequency domain and in a time domain (e.g., RO #0 to RO #7).

As shown in FIG. 9, in the first PRACH slot, a first PRACH transmission (Msg1 #0) may be transmitted in a first PRACH occasion (RO #0) using a first SSB (SSB #0), a second PRACH transmission (Msg1 #1) may be transmitted in a third PRACH occasion (RO #2) using the first SSB, a third PRACH transmission (Msg1 #2) may be transmitted in a fifth PRACH occasion (RO #5) using a second SSB (SSB #1), and a fourth PRACH transmission (Msg1 #3) may be transmitted in an eighth PRACH occasion (RO #7) using the second SSB. In this example, N is 1/4, the number of frequency division multiplexed PRACH occasions is four, N_{Tx}^{SSB} is two, and a quantity of repetitions is four. Further, in this example, the UE may transmit the multiple PRACH transmissions using two hops and different spatial domain filters. The UE may transmit the multiple PRACH transmissions using a hopping configuration for SSB #0 that is different than a hopping configuration for SSB #1.

As indicated above, FIG. 9 is provided as an example. Other examples may differ from what is described with regard to FIG. 9.

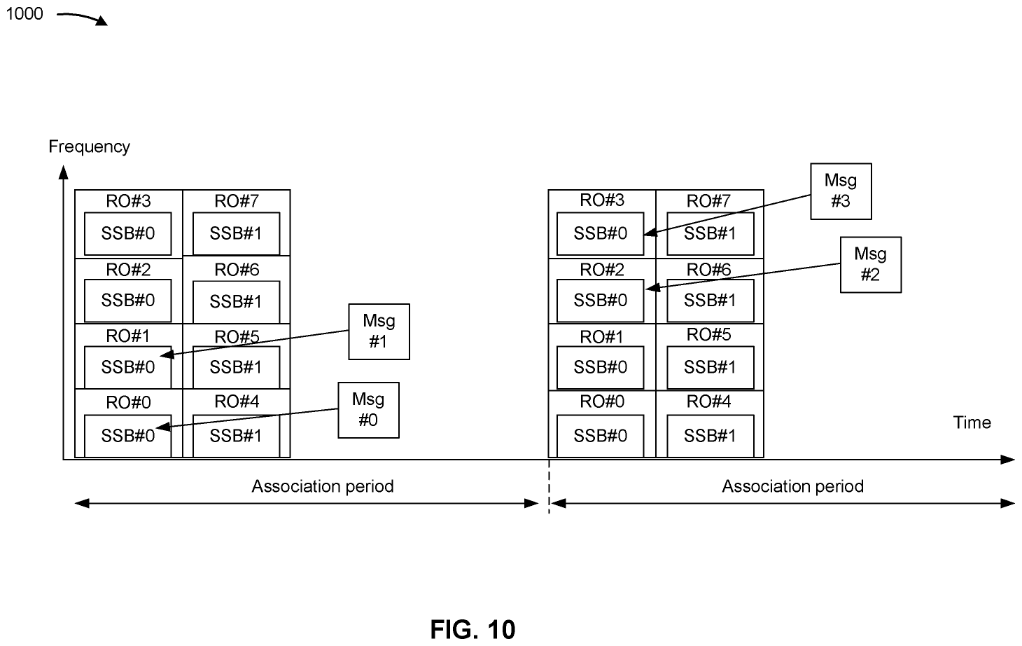

FIG. 10 is a diagram illustrating an example 1000 associated with multiple PRACH transmissions using frequency hopping, in accordance with the present disclosure.

In some aspects, a UE may transmit multiple PRACH (Msg1) transmissions to a network entity using inter-PRACH slot frequency hopping. A first association period may include a first PRACH slot, and a second association period may include a second PRACH slot. Each PRACH slot may be associated with 8 PRACH occasions in a frequency domain and in a time domain (e.g., RO #0 to RO #7).

As shown in FIG. 10, in the first PRACH slot, a first PRACH transmission (Msg1 #0) may be transmitted in a first PRACH occasion (RO #0) using a first SSB (SSB #0), and a second PRACH transmission (Msg1 #1) may be transmitted in a second PRACH occasion (RO #1) using the first SSB. In the second PRACH slot, a third PRACH transmission (Msg1 #2) may be transmitted in a third PRACH occasion (RO #2) using the first SSB, and a fourth PRACH transmission (Msg1 #3) may be transmitted in a fourth PRACH occasion (RO #3) using the first SSB. In this example, N is 1/4, the number of frequency division multiplexed PRACH occasions is four, N_{Tx}^{SSB} is two, and a quantity of repetitions is four. Further, in this example, the UE may transmit the multiple PRACH transmissions using the same spatial domain filters. The UE may perform two PRACH transmissions at the same time, and the UE may perform frequency hopping between the first PRACH slot and the second PRACH slot.

As indicated above, FIG. 10 is provided as an example. Other examples may differ from what is described with regard to FIG. 10.

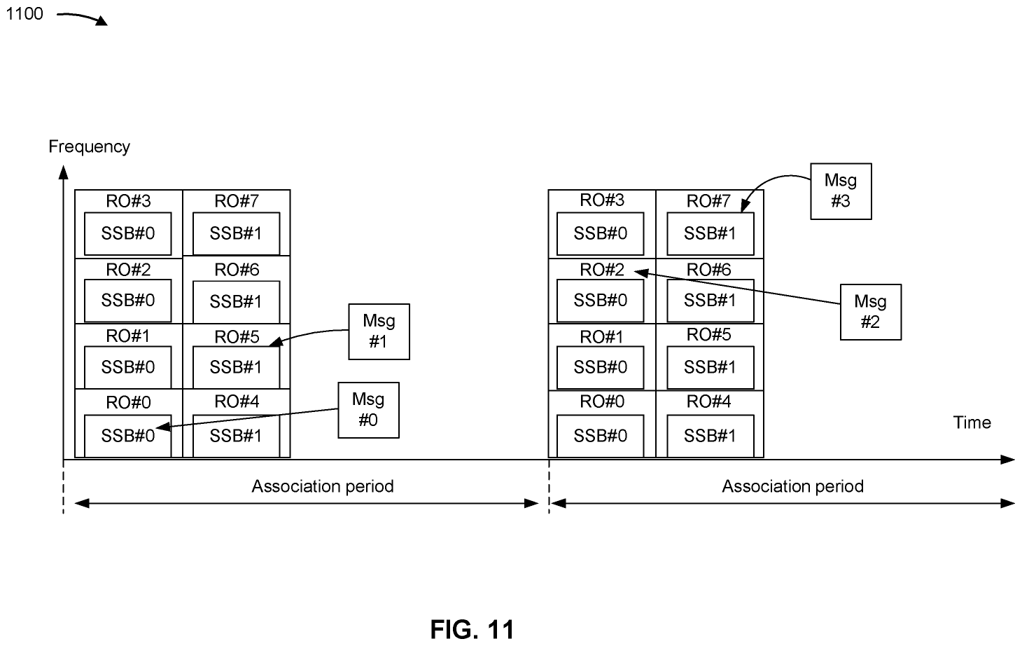

FIG. 11 is a diagram illustrating an example 1100 associated with multiple PRACH transmissions using frequency hopping, in accordance with the present disclosure.

In some aspects, a UE may transmit multiple PRACH (Msg1) transmissions to a network entity using inter-PRACH slot frequency hopping. A first association period may include a first PRACH slot, and a second association period may include a second PRACH slot. Each PRACH slot may be associated with 8 PRACH occasions in a frequency domain and in a time domain (e.g., RO #0 to RO #7).

As shown in FIG. 11, in the first PRACH slot, a first PRACH transmission (Msg1 #0) may be transmitted in a first PRACH occasion (RO #0) using a first SSB (SSB #0), and a second PRACH transmission (Msg1 #1) may be transmitted in a sixth PRACH occasion (RO #5) using a second SSB (SSB #1). In the second PRACH slot, a third PRACH transmission (Msg1 #2) may be transmitted in a third PRACH occasion (RO #2) using the first SSB, and a fourth PRACH transmission (Msg1 #3) may be transmitted in an eighth PRACH occasion (RO #7) using the second SSB. In this example, N is 1/4, the number of frequency division multiplexed PRACH occasions is four, N_{Tx}^{SSB} is two, and a quantity of repetitions is four. Further, in this example, the UE may transmit the multiple PRACH transmissions using different spatial domain filters. The UE may perform one PRACH transmission at a time, and the UE may perform frequency hopping between the first PRACH slot and the second PRACH slot.

As indicated above, FIG. 11 is provided as an example. Other examples may differ from what is described with regard to FIG. 11.

FIG. 12 is a diagram illustrating an example process 1200 performed, for example, by a UE, in accordance with the present disclosure. Example process 1200 is an example where the UE (e.g., UE 120) performs operations associated with multiple PRACH transmissions.

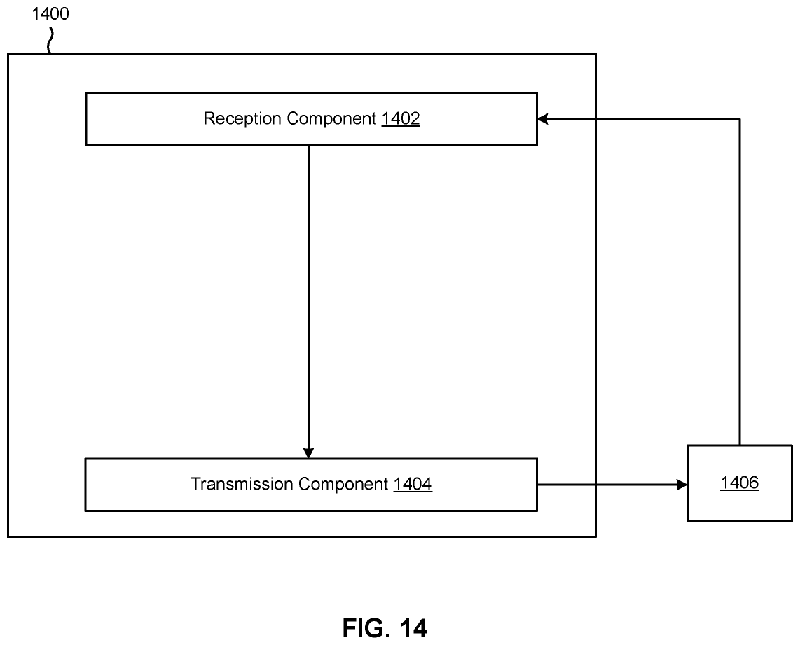

As shown in FIG. 12, in some aspects, process 1200 may include transmitting, to a network entity, multiple PRACH transmissions based at least in part on a PRACH slot frequency hopping (block 1210). For example, the UE (e.g., using transmission component 1404, depicted in FIG. 14) may transmit, to a network entity, multiple PRACH transmissions based at least in part on a PRACH slot frequency hopping, as described above.

As further shown in FIG. 12, in some aspects, process 1200 may include receiving, from the network entity, a response based at least in part on the multiple PRACH transmissions associated with the PRACH slot frequency hopping (block 1220). For example, the UE (e.g., using reception component 1402, depicted in FIG. 14) may receive, from the network entity, a response based at least in part on the multiple PRACH transmissions associated with the PRACH slot frequency hopping, as described above.

Process 1200 may include additional aspects, such as any single aspect or any combination of aspects described below and/or in connection with one or more other processes described elsewhere herein.

In a first aspect, the PRACH slot frequency hopping is an intra-PRACH slot frequency hopping.

In a second aspect, alone or in combination with the first aspect, process 1200 includes transmitting, to the network entity, capability signaling indicating that the UE is capable of performing the multiple PRACH transmissions with the PRACH slot frequency hopping, and transmitting the multiple PRACH transmissions is based at least in part on the capability signaling.

In a third aspect, alone or in combination with one or more of the first and second aspects, transmitting the multiple PRACH transmissions is based at least in part on using the same spatial domain filters or the same transmit beams.

In a fourth aspect, alone or in combination with one or more of the first through third aspects, transmitting the multiple PRACH transmissions is based at least in part on using different spatial domain filters or different transmit beams.

In a fifth aspect, alone or in combination with one or more of the first through fourth aspects, the multiple PRACH transmissions are associated with a common PRACH slot frequency hopping flag indicating that PRACH slot frequency hopping is enabled.

In a sixth aspect, alone or in combination with one or more of the first through fifth aspects, the multiple PRACH transmissions are each associated with a separate PRACH slot frequency hopping flag that indicates whether PRACH slot frequency hopping is enabled.

In a seventh aspect, alone or in combination with one or more of the first through sixth aspects, process 1200 includes receiving, from the network entity, a PRACH slot frequency hopping configuration, and transmitting the multiple PRACH transmissions is based at least in part on the PRACH slot frequency hopping configuration.

In an eighth aspect, alone or in combination with one or more of the first through seventh aspects, the PRACH slot frequency hopping configuration indicates one or more of a frequency hop offset in terms of a quantity of resource blocks in a PRACH occasion or a quantity of PRACH occasions in a PRACH slot, and a quantity of hops based at least in part on a quantity of synchronization signal blocks associated with the PRACH occasion and a quantity of frequency division multiplexed PRACH occasions.

In a ninth aspect, alone or in combination with one or more of the first through eighth aspects, the PRACH slot frequency hopping configuration is: common for multiple PRACH transmissions using the same spatial domain filters, separate for multiple PRACH transmissions using the same spatial domain filters, common for multiple PRACH transmissions using different spatial domain filters, or separate for multiple PRACH transmissions using different spatial domain filters.

In a tenth aspect, alone or in combination with one or more of the first through ninth aspects, the PRACH slot frequency hopping is an inter-PRACH slot frequency hopping.

In an eleventh aspect, alone or in combination with one or more of the first through tenth aspects, the PRACH slot frequency hopping is based at least in part on one or more of a system frame number, a slot number, or an association period associated with the multiple PRACH transmissions.

Although FIG. 12 shows example blocks of process 1200, in some aspects, process 1200 may include additional blocks, fewer blocks, different blocks, or differently arranged blocks than those depicted in FIG. 12. Additionally, or alternatively, two or more of the blocks of process 1200 may be performed in parallel.

FIG. 13 is a diagram illustrating an example process 1300 performed, for example, by a network entity, in accordance with the present disclosure. Example process 1300 is an example where the network entity (e.g., base station 110) performs operations associated with multiple PRACH transmissions.

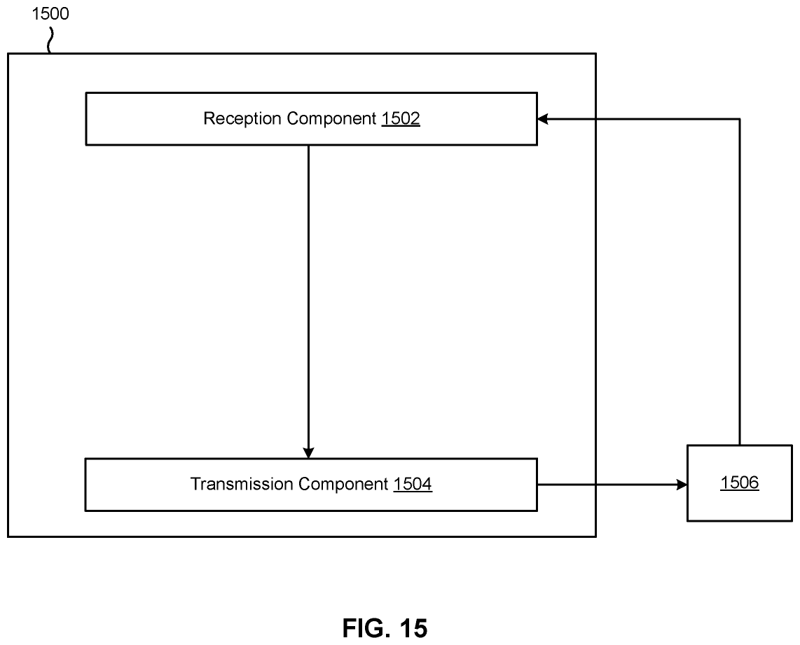

As shown in FIG. 13, in some aspects, process 1300 may include receiving, from a UE, multiple PRACH transmissions based at least in part on a PRACH slot frequency hopping (block 1310). For example, the network entity (e.g., using reception component 1502, depicted in FIG. 15) may receive, from a UE, multiple PRACH transmissions based at least in part on a PRACH slot frequency hopping, as described above.

As further shown in FIG. 13, in some aspects, process 1300 may include transmitting, to the UE, a response based at least in part on the multiple PRACH transmissions associated with the PRACH slot frequency hopping (block 1320). For example, the network entity (e.g., using transmission component 1504, depicted in FIG. 15) may transmit, to the UE, a response based at least in part on the multiple PRACH transmissions associated with the PRACH slot frequency hopping, as described above.

Process 1300 may include additional aspects, such as any single aspect or any combination of aspects described below and/or in connection with one or more other processes described elsewhere herein.

In a first aspect, the PRACH slot frequency hopping is an intra-PRACH slot frequency hopping or an inter-PRACH slot frequency hopping.

In a second aspect, alone or in combination with the first aspect, process 1300 includes receiving, from the UE, one or more of capability signaling or a PRACH slot frequency hopping configuration, and receiving the multiple PRACH transmissions is based at least in part on the one or more of the capability signaling or the PRACH slot frequency hopping configuration.

Although FIG. 13 shows example blocks of process 1300, in some aspects, process 1300 may include additional blocks, fewer blocks, different blocks, or differently arranged blocks than those depicted in FIG. 13. Additionally, or alternatively, two or more of the blocks of process 1300 may be performed in parallel.

FIG. 14 is a diagram of an example apparatus 1400 for wireless communication. The apparatus 1400 may be a UE, or a UE may include the apparatus 1400. In some aspects, the apparatus 1400 includes a reception component 1402 and a transmission component 1404, which may be in communication with one another (for example, via one or more buses and/or one or more other components). As shown, the apparatus 1400 may communicate with another apparatus 1406 (such as a UE, a base station, or another wireless communication device) using the reception component 1402 and the transmission component 1404.

In some aspects, the apparatus 1400 may be configured to perform one or more operations described herein in connection with FIGS. 7-11. Additionally, or alternatively, the apparatus 1400 may be configured to perform one or more processes described herein, such as process 1200 of FIG. 12. In some aspects, the apparatus 1400 and/or one or more components shown in FIG. 14 may include one or more components of the UE described in connection with FIG. 2. Additionally, or alternatively, one or more components shown in FIG. 14 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1402 may receive communications, such as reference signals, control information, data communications, or a combination thereof, from the apparatus 1406. The reception component 1402 may provide received communications to one or more other components of the apparatus 1400. In some aspects, the reception component 1402 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1400. In some aspects, the reception component 1402 may include one or more antennas, a modem, a demodulator, a MIMO detector, a receive processor, a controller/processor, a memory, or a combination thereof, of the UE described in connection with FIG. 2.

The transmission component 1404 may transmit communications, such as reference signals, control information, data communications, or a combination thereof, to the apparatus 1406. In some aspects, one or more other components of the apparatus 1400 may generate communications and may provide the generated communications to the transmission component 1404 for transmission to the apparatus 1406. In some aspects, the transmission component 1404 may perform signal processing on the generated communications (such as filtering, amplification, modulation, digital-to-analog conversion, multiplexing, interleaving, mapping, or encoding, among other examples), and may transmit the processed signals to the apparatus 1406. In some aspects, the transmission component 1404 may include one or more antennas, a modem, a modulator, a transmit MIMO processor, a transmit processor, a controller/processor, a memory, or a combination thereof, of the UE described in connection with FIG. 2. In some aspects, the transmission component 1404 may be co-located with the reception component 1402 in a transceiver.

The transmission component 1404 may transmit, to a network entity, multiple PRACH transmissions based at least in part on a PRACH slot frequency hopping. The reception component 1402 may receive, from the network entity, a response based at least in part on the multiple PRACH transmissions associated with the PRACH slot frequency hopping. The transmission component 1404 may transmit, to the network entity, capability signaling indicating that the UE is capable of performing the multiple PRACH transmissions with the PRACH slot frequency hopping.

The number and arrangement of components shown in FIG. 14 are provided as an example. In practice, there may be additional components, fewer components, different components, or differently arranged components than those shown in FIG. 14. Furthermore, two or more components shown in FIG. 14 may be implemented within a single component, or a single component shown in FIG. 14 may be implemented as multiple, distributed components. Additionally, or alternatively, a set of (one or more) components shown in FIG. 14 may perform one or more functions described as being performed by another set of components shown in FIG. 14.

FIG. 15 is a diagram of an example apparatus 1500 for wireless communication. The apparatus 1500 may be a network entity, or a network entity may include the apparatus 1500. In some aspects, the apparatus 1500 includes a reception component 1502 and a transmission component 1504, which may be in communication with one another (for example, via one or more buses and/or one or more other components). As shown, the apparatus 1500 may communicate with another apparatus 1506 (such as a UE, a base station, or another wireless communication device) using the reception component 1502 and the transmission component 1504.

In some aspects, the apparatus 1500 may be configured to perform one or more operations described herein in connection with FIGS. 7-11. Additionally, or alternatively, the apparatus 1500 may be configured to perform one or more processes described herein, such as process 1300 of FIG. 13. In some aspects, the apparatus 1500 and/or one or more components shown in FIG. 15 may include one or more components of the network entity described in connection with FIG. 2. Additionally, or alternatively, one or more components shown in FIG. 15 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1502 may receive communications, such as reference signals, control information, data communications, or a combination thereof, from the apparatus 1506. The reception component 1502 may provide received communications to one or more other components of the apparatus 1500. In some aspects, the reception component 1502 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1500. In some aspects, the reception component 1502 may include one or more antennas, a modem, a demodulator, a MIMO detector, a receive processor, a controller/processor, a memory, or a combination thereof, of the network entity described in connection with FIG. 2.

The transmission component 1504 may transmit communications, such as reference signals, control information, data communications, or a combination thereof, to the apparatus 1506. In some aspects, one or more other components of the apparatus 1500 may generate communications and may provide the generated communications to the transmission component 1504 for transmission to the apparatus 1506. In some aspects, the transmission component 1504 may perform signal processing on the generated communications (such as filtering, amplification, modulation, digital-to-analog conversion, multiplexing, interleaving, mapping, or encoding, among other examples), and may transmit the processed signals to the apparatus 1506. In some aspects, the transmission component 1504 may include one or more antennas, a modem, a modulator, a transmit MIMO processor, a transmit processor, a controller/processor, a memory, or a combination thereof, of the network entity described in connection with FIG. 2. In some aspects, the transmission component 1504 may be co-located with the reception component 1502 in a transceiver.

The reception component 1502 may receive, from a UE, multiple PRACH transmissions based at least in part on a PRACH slot frequency hopping. The transmission component 1504 may transmit, to the UE, a response based at least in part on the multiple PRACH transmissions associated with the PRACH slot frequency hopping. The reception component 1502 may receive, from the UE, one or more of capability signaling or a PRACH slot frequency hopping configuration.

The number and arrangement of components shown in FIG. 15 are provided as an example. In practice, there may be additional components, fewer components, different components, or differently arranged components than those shown in FIG. 15. Furthermore, two or more components shown in FIG. 15 may be implemented within a single component, or a single component shown in FIG. 15 may be implemented as multiple, distributed components. Additionally, or alternatively, a set of (one or more) components shown in FIG. 15 may perform one or more functions described as being performed by another set of components shown in FIG. 15.

The following provides an overview of some Aspects of the present disclosure:

Aspect 1: A method of wireless communication performed by a user equipment (UE), comprising: transmitting, to a network entity, multiple physical random access channel (PRACH) transmissions based at least in part on a PRACH slot frequency hopping; and receiving, from the network entity, a response based at least in part on the multiple PRACH transmissions associated with the PRACH slot frequency hopping.

Aspect 2: The method of Aspect 1, wherein the PRACH slot frequency hopping is an intra-PRACH slot frequency hopping.

Aspect 3: The method of any of Aspects 1 through 2, further comprising: transmitting, to the network entity, capability signaling indicating that the UE is capable of performing the multiple PRACH transmissions with the PRACH slot frequency hopping, wherein transmitting the multiple PRACH transmissions is based at least in part on the capability signaling.

Aspect 4: The method of any of Aspects 1 through 3, wherein transmitting the multiple PRACH transmissions is based at least in part on using same spatial domain filters or same transmit beams.

Aspect 5: The method of any of Aspects 1 through 4, wherein transmitting the multiple PRACH transmissions is based at least in part on using different spatial domain filters or different transmit beams.

Aspect 6: The method of any of Aspects 1 through 5, wherein the multiple PRACH transmissions are associated with a common PRACH slot frequency hopping flag indicating that PRACH slot frequency hopping is enabled.

Aspect 7: The method of any of Aspects 1 through 6, wherein the multiple PRACH transmissions are each associated with a separate PRACH slot frequency hopping flag that indicates whether PRACH slot frequency hopping is enabled.

Aspect 8: The method of any of Aspects 1 through 7, further comprising: receiving, from the network entity, a PRACH slot frequency hopping configuration; and wherein transmitting the multiple PRACH transmissions is based at least in part on the PRACH slot frequency hopping configuration, wherein transmitting the multiple PRACH transmissions is based at least in part on the PRACH slot frequency hopping configuration.

Aspect 9: The method of Aspect 8, wherein the PRACH slot frequency hopping configuration indicates one or more of: a frequency hop offset in terms of a quantity of resource blocks in a PRACH occasion or a quantity of PRACH occasions in a PRACH slot; and a quantity of hops based at least in part on a quantity of synchronization signal blocks associated with the PRACH occasion and a quantity of frequency division multiplexed PRACH occasions.

Aspect 10: The method of Aspect 8, wherein the PRACH slot frequency hopping configuration is: common for multiple PRACH transmissions using same spatial domain filters; separate for multiple PRACH transmissions using same spatial domain filters; common for multiple PRACH transmissions using different spatial domain filters; or separate for multiple PRACH transmissions using different spatial domain filters.

Aspect 11: The method of any of Aspects 1 through 10, wherein the PRACH slot frequency hopping is an inter-PRACH slot frequency hopping.

Aspect 12: The method of any of Aspects 1 through 11, wherein the PRACH slot frequency hopping is based at least in part on one or more of: a system frame number, a slot number, or an association period associated with the multiple PRACH transmissions.

Aspect 13: A method of wireless communication performed by a network entity, comprising: receiving, from a user equipment (UE), multiple physical random access channel (PRACH) transmissions based at least in part on a PRACH slot frequency hopping; and transmitting, to the UE, a response based at least in part on the multiple PRACH transmissions associated with the PRACH slot frequency hopping.

Aspect 14: The method of Aspect 13, wherein the PRACH slot frequency hopping is an intra-PRACH slot frequency hopping or an inter-PRACH slot frequency hopping.

Aspect 15: The method of any of Aspects 13 through 14, further comprising: receiving, from the UE, one or more of capability signaling or a PRACH slot frequency hopping configuration, wherein receiving the multiple PRACH transmissions is based at least in part on the one or more of the capability signaling or the PRACH slot frequency hopping configuration.

Aspect 16: An apparatus for wireless communication at a device, comprising a processor; memory coupled with the processor; and instructions stored in the memory and executable by the processor to cause the apparatus to perform the method of one or more of Aspects 1-12.

Aspect 17: A device for wireless communication, comprising a memory and one or more processors coupled to the memory, the one or more processors configured to perform the method of one or more of Aspects 1-12.

Aspect 18: An apparatus for wireless communication, comprising at least one means for performing the method of one or more of Aspects 1-12.

Aspect 19: A non-transitory computer-readable medium storing code for wireless communication, the code comprising instructions executable by a processor to perform the method of one or more of Aspects 1-12.

Aspect 20: A non-transitory computer-readable medium storing a set of instructions for wireless communication, the set of instructions comprising one or more instructions that, when executed by one or more processors of a device, cause the device to perform the method of one or more of Aspects 1-12.

Aspect 21: An apparatus for wireless communication at a device, comprising a processor; memory coupled with the processor; and instructions stored in the memory and executable by the processor to cause the apparatus to perform the method of one or more of Aspects 13-15.

Aspect 22: A device for wireless communication, comprising a memory and one or more processors coupled to the memory, the one or more processors configured to perform the method of one or more of Aspects 13-15.

Aspect 23: An apparatus for wireless communication, comprising at least one means for performing the method of one or more of Aspects 13-15.

Aspect 24: A non-transitory computer-readable medium storing code for wireless communication, the code comprising instructions executable by a processor to perform the method of one or more of Aspects 13-15.

Aspect 25: A non-transitory computer-readable medium storing a set of instructions for wireless communication, the set of instructions comprising one or more instructions that, when executed by one or more processors of a device, cause the device to perform the method of one or more of Aspects 13-15.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a “processor” is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods are described herein without reference to specific software code, since those skilled in the art will understand that software and hardware can be designed to implement the systems and/or methods based, at least in part, on the description herein.

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. Many of these features may be combined in ways not specifically recited in the claims and/or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. An apparatus for wireless communication at a user equipment (UE), comprising:
a memory; and
one or more processors, coupled to the memory, configured to:
transmit, to a network entity, multiple physical random access channel (PRACH) transmissions based at least in part on a PRACH slot frequency hopping; and
receive, from the network entity, a response based at least in part on the multiple PRACH transmissions associated with the PRACH slot frequency hopping.

2. The apparatus of claim 1, wherein the PRACH slot frequency hopping is an intra-PRACH slot frequency hopping.

3. The apparatus of claim 1, wherein the one or more processors are further configured to:
transmit, to the network entity, capability signaling indicating that the UE is capable of performing the multiple PRACH transmissions with the PRACH slot frequency hopping; and
transmit the multiple PRACH transmissions based at least in part on the capability signaling.

4. The apparatus of claim 1, wherein the one or more processors are configured to transmit the multiple PRACH transmissions based at least in part on using same spatial domain filters or same transmit beams.

5. The apparatus of claim 1, wherein the one or more processors are configured to transmit the multiple PRACH transmissions based at least in part on using different spatial domain filters or different transmit beams.

6. The apparatus of claim 1, wherein the multiple PRACH transmissions are associated with a common PRACH slot frequency hopping flag indicating that PRACH slot frequency hopping is enabled.

7. The apparatus of claim 1, wherein the multiple PRACH transmissions are each associated with a separate PRACH slot frequency hopping flag that indicates whether PRACH slot frequency hopping is enabled.

8. The apparatus of claim 1, wherein the one or more processors are further configured to:
receive, from the network entity, a PRACH slot frequency hopping configuration; and
transmit the multiple PRACH transmissions based at least in part on the PRACH slot frequency hopping configuration.

9. The apparatus of claim 8, wherein the PRACH slot frequency hopping configuration indicates one or more of:
a frequency hop offset in terms of a quantity of resource blocks in a PRACH occasion or a quantity of PRACH occasions in a PRACH slot; and
a quantity of hops based at least in part on a quantity of synchronization signal blocks associated with the PRACH occasion and a quantity of frequency division multiplexed PRACH occasions.

10. The apparatus of claim 8, wherein the PRACH slot frequency hopping configuration is:
common for multiple PRACH transmissions using same spatial domain filters;
separate for multiple PRACH transmissions using same spatial domain filters;
common for multiple PRACH transmissions using different spatial domain filters; or
separate for multiple PRACH transmissions using different spatial domain filters.

11. The apparatus of claim 1, wherein the PRACH slot frequency hopping is an inter-PRACH slot frequency hopping.

12. The apparatus of claim 1, wherein the PRACH slot frequency hopping is based at least in part on one or more of: a system frame number, a slot number, or an association period associated with the multiple PRACH transmissions.

13. An apparatus for wireless communication at a network entity, comprising:
a memory; and
one or more processors, coupled to the memory, configured to:
receive, from a user equipment (UE), multiple physical random access channel (PRACH) transmissions based at least in part on a PRACH slot frequency hopping; and
transmit, to the UE, a response based at least in part on the multiple PRACH transmissions associated with the PRACH slot frequency hopping.

14. The apparatus of claim 13, wherein the PRACH slot frequency hopping is an intra-PRACH slot frequency hopping or an inter-PRACH slot frequency hopping.

15. The apparatus of claim 13, wherein the one or more processors are further configured to:
receive, from the UE, one or more of capability signaling or a PRACH slot frequency hopping configuration; and
receive the multiple PRACH transmissions based at least in part on the one or more of the capability signaling or the PRACH slot frequency hopping configuration.

16. A method of wireless communication performed by a user equipment (UE), comprising:
transmitting, to a network entity, multiple physical random access channel (PRACH) transmissions based at least in part on a PRACH slot frequency hopping; and
receiving, from the network entity, a response based at least in part on the multiple PRACH transmissions associated with the PRACH slot frequency hopping.

17. The method of claim 16, wherein the PRACH slot frequency hopping is an intra-PRACH slot frequency hopping.

18. The method of claim 16, further comprising:
transmitting, to the network entity, capability signaling indicating that the UE is capable of performing the multiple PRACH transmissions with the PRACH slot frequency hopping,
wherein transmitting the multiple PRACH transmissions is based at least in part on the capability signaling.

19. The method of claim 16, wherein transmitting the multiple PRACH transmissions is based at least in part on using same spatial domain filters or same transmit beams.

20. The method of claim 16, wherein transmitting the multiple PRACH transmissions is based at least in part on using different spatial domain filters or different transmit beams.

21. The method of claim 16, wherein the multiple PRACH transmissions are associated with a common PRACH slot frequency hopping flag indicating that PRACH slot frequency hopping is enabled.

22. The method of claim 16, wherein the multiple PRACH transmissions are each associated with a separate PRACH slot frequency hopping flag that indicates whether PRACH slot frequency hopping is enabled.

23. The method of claim 16, further comprising:
receiving, from the network entity, a PRACH slot frequency hopping configuration; and
wherein transmitting the multiple PRACH transmissions is based at least in part on the PRACH slot frequency hopping configuration.

24. The method of claim 23, wherein the PRACH slot frequency hopping configuration indicates one or more of:
a frequency hop offset in terms of a quantity of resource blocks in a PRACH occasion or a quantity of PRACH occasions in a PRACH slot; and
a quantity of hops based at least in part on a quantity of synchronization signal blocks associated with the PRACH occasion and a quantity of frequency division multiplexed PRACH occasions.

25. The method of claim 23, wherein the PRACH slot frequency hopping configuration is:
common for multiple PRACH transmissions using same spatial domain filters;
separate for multiple PRACH transmissions using same spatial domain filters;
common for multiple PRACH transmissions using different spatial domain filters; or
separate for multiple PRACH transmissions using different spatial domain filters.

26. The method of claim 16, wherein the PRACH slot frequency hopping is an inter-PRACH slot frequency hopping.

27. The method of claim 16, wherein the PRACH slot frequency hopping is based at least in part on one or more of: a system frame number, a slot number, or an association period associated with the multiple PRACH transmissions.

28. A method of wireless communication performed by a network entity, comprising:
receiving, from a user equipment (UE), multiple physical random access channel (PRACH) transmissions based at least in part on a PRACH slot frequency hopping; and
transmitting, to the UE, a response based at least in part on the multiple PRACH transmissions associated with the PRACH slot frequency hopping.

29. The method of claim 28, wherein the PRACH slot frequency hopping is an intra-PRACH slot frequency hopping or an inter-PRACH slot frequency hopping.

30. The method of claim 28, further comprising:
receiving, from the UE, one or more of capability signaling or a PRACH slot frequency hopping configuration; and
wherein receiving the multiple PRACH transmissions is based at least in part on the one or more of the capability signaling or the PRACH slot frequency hopping configuration.
